(19) United States
(12) Patent Application Publication
(10) Pub. No.: US 2020/0387187 A1
(43) Pub. Date: Dec. 10, 2020

(54) ROCKER APPARATUS AND REMOTE CONTROLLER HAVING SAME

(71) Applicant: AUTEL ROBOTICS CO., LTD., Shenzhen (CN)

(72) Inventor: Zhiying LIANG, Shenzhen (CN)

(21) Appl. No.: 16/810,644

(22) Filed: Mar. 5, 2020

Related U.S. Application Data
(63) Continuation of application No. PCT/CN2018/083755, filed on Apr. 19, 2018.

(30) Foreign Application Priority Data
Sep. 5, 2017 (CN) 201710791417.8

(51) Int. Cl. G05G 9/047; G06F 3/0338; G06F 1/16

(52) U.S. Cl. CPC G05G 9/047; G06F 3/0338; G05G 2009/04766; G05G 2009/04733; G05G 2009/04714; G06F 1/169

(57) ABSTRACT

The present invention relates to the field of remote control technologies and provides a rocker apparatus and a remote controller. The rocker apparatus includes a housing, a lever assembly, a magnetic element and a circuit board. The lever assembly is mounted in the housing and can move in parallel with the housing. The magnetic element is mounted in the lever assembly. The circuit board includes a magnetic sensor, the magnetic sensor being configured to sense a magnetic field change of the magnetic element. When the lever assembly moves in parallel with the housing, the magnetic element is driven by the lever assembly to move with respect to the magnetic sensor in any direction in a plane.

### BACKGROUND

This application is a continuation application of International Application No. PCT/CN2018/083755, filed on Apr. 19, 2018, which claims priority of Chinese Patent Application No. 201710791417.8, filed on Sep. 5, 2017, which is incorporated herein by reference in its entirely.

### Technical Field

The present invention relates to the field of remote control technologies, and in particular, to a rocker apparatus and a remote controller having the same.

### Related Art

Currently, an increasing number of electronic products such as unmanned aerial vehicles (UAVs), navigation models and electronic toys adopt a remote control technology, that is, are operated by using remote controllers.

Rocker apparatuses are basically disposed on all remote controllers. However, a traditional rocker apparatus controls flight maneuvers such as forward, backward, leftward, rightward flight maneuvers by using a swinging rotational operation. An operation of the rocker apparatus does not vividly correspond to an actual movement of a remotely controlled motorized apparatus. Simulation performance is not good. Consequently, it is difficult for users to remember various correspondences and even misoperations are caused, leading to poor user experience.

### SUMMARY

To resolve the foregoing technical problem, embodiments of the present invention provide a rocker apparatus easy to operate and a remote controller having the same.

The embodiments of the present invention adopt the following technical solution to resolve the technical problem:

A rocker apparatus includes:

a housing;

a lever assembly mounted in the housing, the lever assembly being capable of moving in parallel with the housing;

a magnetic element, the magnetic element being mounted in the lever assembly; and

a circuit board including a magnetic sensor, the magnetic sensor being configured to sense a magnetic field change of the magnetic element.

When the lever assembly moves in parallel with the housing, the magnetic element is driven by the lever assembly to move with respect to the magnetic sensor in any direction in a plane.

Optionally, the lever assembly intersects with the plane.

Optionally, when the lever assembly moves in parallel with the housing, any two points on the lever assembly move in a same direction by a same distance.

Optionally, when the lever assembly moves in parallel with the housing, the lever assembly does not rotate.

Optionally, the magnetic element is fixedly mounted on the lever assembly, when the lever assembly moves in parallel with the housing, the magnetic element moving in parallel with the magnetic sensor.

Optionally, the rocker apparatus (100) further includes a reset mechanism, when the lever assembly deviates from an initial position of the lever assembly, the reset mechanism generating a force for resetting the lever assembly.

Optionally, the reset mechanism includes a first reset assembly and a second reset assembly. When the lever assembly deviates from the initial position of the lever assembly, the first reset assembly and the second reset assembly generate a resultant force for resetting the lever assembly.

Optionally, the first reset assembly is capable of generating a force for pushing the lever assembly along a first axis and the second reset assembly is capable of generating a force for pushing the lever assembly along a second axis.

When the lever assembly deviates from the initial position of the lever assembly, at least one of the first reset assembly and the second reset assembly generates a force for pushing the lever assembly along a corresponding axis, so that the lever assembly returns to the initial position of the lever assembly after being released, the first axis being not parallel to the second axis.

Optionally, the first axis is perpendicular to the second axis.

Optionally, the first reset assembly includes a first movable block, a first elastic element and a first mount, the first movable block being mounted on the first mount.

Optionally, there are two first movable blocks, there are two first elastic elements and a first accommodation groove is formed on the first mount.

The first accommodation groove is formed along the first axis, the two first movable blocks being accommodated in the first accommodation groove and disposed at two opposite sides of the lever assembly along the first axis.

One end of each first elastic element is connected to an inner side wall of the first accommodation groove and the other end of each first elastic element is connected to one corresponding first movable block.

Optionally, each first movable block includes a first fixing portion.

A second fixing portion is disposed at each of two opposite sides of the inner side wall of the first accommodation groove.

One end of each first elastic element is mounted at one second fixing portion of the first accommodation groove and the other end of each first elastic element is mounted at the first fixing portion of one corresponding first movable block.

Optionally, the first fixing portion and the second fixing portion are any of the following:

a fixing post, a slot and a hook-shaped projection.

Optionally, a first limiting post is further disposed on the first accommodation groove, the first limiting post being disposed between the two first movable blocks to separate the two first movable blocks by a preset distance.

Optionally, the second reset assembly includes a second movable block, a second elastic element and a second mount, the second movable block being mounted on the second mount.

Optionally, there are two second movable blocks, there are two second elastic elements and a second accommodation groove is formed on the second mount.

The second accommodation groove is formed along the second axis, the two second movable blocks being accommodated in the second accommodation groove and disposed at two opposite sides of the lever assembly along the second axis.

One end of each second elastic element is connected to an inner side wall of the second accommodation groove and the other end of each second elastic element is connected to one corresponding second movable block.

Optionally, each second movable block includes a third fixing portion.

A fourth fixing portion is disposed at each of two opposite sides of the inner side wall of the second accommodation groove.

One end of each second elastic element is mounted at one fourth fixing portion of the second accommodation groove and the other end of each second elastic element is mounted at the third fixing portion of one corresponding second movable block.

Optionally, the third fixing portion and the fourth fixing portion are any of the following: a fixing post, a slot and a hook-shaped projection.

Optionally, a second limiting post is further disposed on the second accommodation groove, the second limiting post being disposed between the two second movable blocks to separate the two second movable blocks by a preset distance.

Optionally, the housing is provided with a first through hole, the first through hole reserving movement space for movement of the lever assembly in parallel with the housing.

Optionally, an annular limiting portion is further disposed on the housing and the lever assembly includes a slide portion, when the lever assembly moves in parallel with the housing to a position, the slide portion abutting against the annular limiting portion, to limit a movement range of the lever assembly in a space defined by the annular limiting portion.

Optionally, the housing includes a first housing portion and a second housing portion, the first housing portion and the second housing portion being engaged with each other to form a cavity.

The lever assembly is partially accommodated in the cavity and the magnetic element and the circuit board are accommodated in the cavity.

Optionally, the first housing portion and the second housing portion each include a bottom wall and a side wall extending from an outer edge of the bottom wall.

Optionally, the magnetic sensor is a Hall element or a magnetic encoder.

The embodiments of the present invention further adopt the following technical solution to resolve the technical problem:

A remote controller includes an enclosure and the rocker apparatus described above, the rocker apparatus being mounted in the enclosure.

Optionally, the magnetic sensor senses a movement position of the magnetic element by sensing the magnetic field change of the magnetic element.

The remote controller further includes a processing unit, the processing unit being configured to generate a remote control instruction based on the movement position of the magnetic element that is sensed by the magnetic sensor.

Compared with the prior art, when the lever assembly moves in parallel with the housing, the magnetic element can be driven by the lever assembly to move from an initial position of the magnetic element with respect to the magnetic sensor in any direction in the plane, so that a movement direction of the lever assembly is set to correspond to a movement direction of a remotely controlled motorized apparatus. In this way, operations for the rocker apparatus are intuitive and simple, facilitating memorization of users.

In addition, the first reset assembly and the second reset assembly may generate a resultant force for resetting the lever assembly, so that the magnetic element is reset to the initial position of the magnetic element in the plane, further simplifying operations.

### BRIEF DESCRIPTION OF THE DRAWINGS

One or more embodiments are exemplarily described by using figures that are corresponding thereto in the accompanying drawings. The exemplary descriptions do not constitute a limitation on the embodiments. Elements with a same reference numeral in the accompanying drawings represent similar elements. Unless otherwise particularly stated, the figures in the accompanying drawings constitute no proportion limitation.

FIG. 1 is a simplified three-dimensional diagram of a remote controller according to an embodiment of the present invention;

FIG. 2 is a simplified three-dimensional diagram of a rocker apparatus according to an embodiment of the present invention;

FIG. 3 is a cross-sectional view of the rocker apparatus shown in FIG. 2;

FIG. 4 is a cross-sectional view of the rocker apparatus shown in FIG. 2 from another viewing angle;

FIG. 5 is an exploded view of the rocker apparatus shown in FIG. 2;

FIG. 6 is an exploded view of the rocker apparatus shown in FIG. 2 from another viewing angle;

FIG. 7 is a cross-sectional view of the rocker apparatus shown in FIG. 2, where a rod body of the rocker apparatus is pushed to move along a first axis;

FIG. 8 is a cross-sectional view of the rocker apparatus shown in FIG. 2 from another viewing angle, where a rod body of the rocker apparatus is pushed to move along the first axis;

FIG. 9 is a cross-sectional view of the rocker apparatus shown in FIG. 2, where a rod body of the rocker apparatus is pushed to move along a second axis; and

FIG. 10 is a cross-sectional view of the rocker apparatus shown in FIG. 2 from another viewing angle, where a rod body of the rocker apparatus is pushed to move along the second axis.

### DETAILED DESCRIPTION

For ease of understanding the present invention, the present invention is described in further detail below with reference to the accompanying drawings and specific embodiments. It should be noted that when an element is described as being “fixed” on another element, the element may be directly on the another element, or one or more intermediate elements may exist therebetween. When an element is described as being “electrically connected” to another element, the element may be directly connected to the another element, or one or more intermediate elements may exist therebetween. Directions or location relationships indicated by terms such as “above”, “below”, “inside”, “outside” and “bottom” used in this specification are based on directions or location relationships shown in the accompanying drawings and are merely for ease of describing the present invention and simplifying descriptions rather than indicating or suggesting that a directed apparatus or element must have a specific direction and be constructed and operated in a specific direction, and therefore cannot be understood as a limitation on the present invention. In addition, terms such as “first”, “second” and “third” are merely used for the purpose of description and cannot be understood as indicating or suggesting relative importance.

Unless otherwise defined, meanings of all technical and scientific terms used in this specification are the same as that usually understood by persons skilled in the technical field to which the present invention belongs. The terms used in the specification of the present invention are merely for describing the specific embodiments, and are not intended to limit the present invention. A term “and/or” used in this specification includes any or all combinations of one or more related listed items.

In addition, in the following descriptions, technical features provided in the different embodiments of the present invention may be mutually combined provided that the technical features do not conflict with each other.

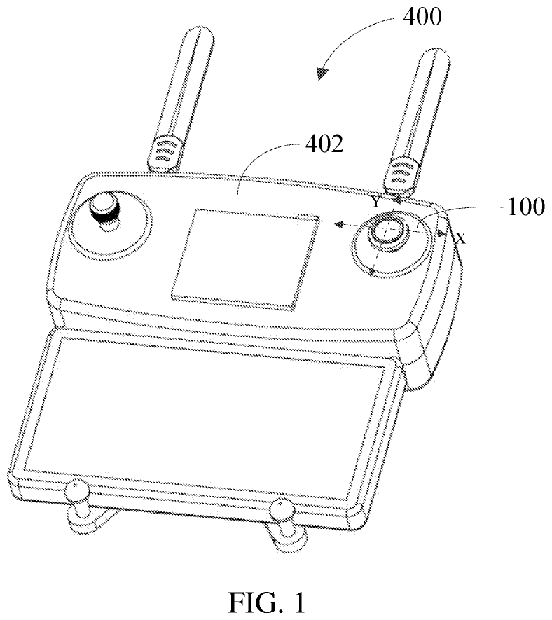

Referring to FIG. 1, FIG. 1 shows a remote controller 400 according to an embodiment of the present invention. The remote controller 400 includes an enclosure 402 and a rocker apparatus 100 mounted in the enclosure 402. The remote controller 400 may be configured to remotely control a movable object. The movable object may be a UAV, a navigation model, an electronic toy, or the like.

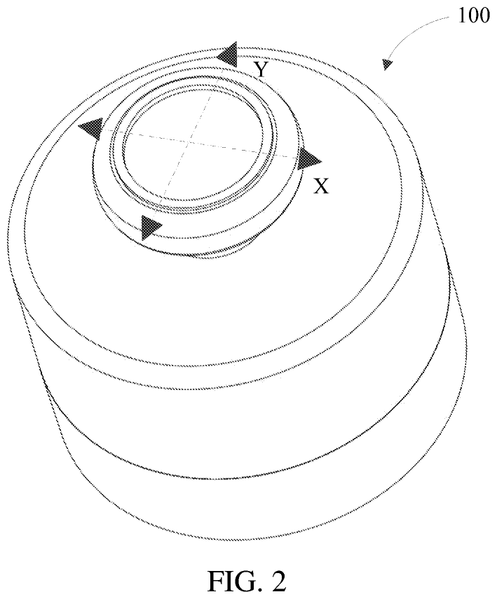

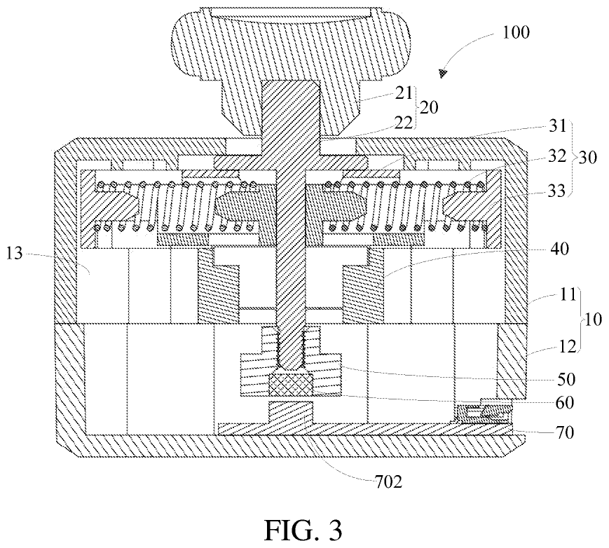

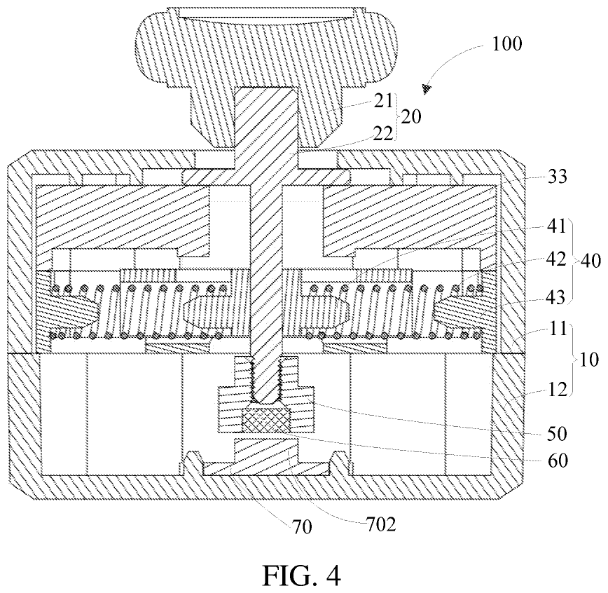

Referring to FIG. 2 to FIG. 4, the rocker apparatus 100 includes a housing 10, a lever assembly 20, a first reset assembly 30, a second reset assembly 40, a fixing member 50, a magnetic element 60 and a circuit board 70.

The lever assembly 20 is partially accommodated in the housing 10. The first reset assembly 30, the second reset assembly 40, the fixing member 50, the magnetic element 60 and the circuit board 70 are accommodated in the housing 10.

One end of the lever assembly 20 is connected to the magnetic element 60 via the fixing member 50. When the lever assembly 20 moves in parallel with the housing 10, the magnetic element 60 is driven by the lever assembly 20 to move in parallel with the circuit board 70 from an initial position of the magnetic element 60 in any direction in a plane. The circuit board 70 is parallel to the plane and the lever assembly 20 intersects with the plane.

In this embodiment of the present invention, an “initial position” of the lever assembly refers to an original position of the lever assembly in a natural state when the lever assembly has not been toggled by a user. Generally, when the lever assembly is located at the initial position of the lever assembly, a central axis of a rod body of the lever assembly coincides with a central axis of the rocker apparatus. The “initial position” of the magnetic element also refers to an original position of the magnetic element in a natural state when the magnetic element has not been toggled by the user. Generally, when the magnetic element is located at a central position of the magnetic element, a center point of the magnetic element runs through the central axis of the rocker apparatus.

“Moving in parallel” in this embodiment of the present invention means that all points on one component move in a direction by a same distance and the component does not rotate with respect to any point on the component. When the lever assembly 20 moves in parallel with the housing 10, any two points on the lever assembly 20 move in a same direction by a same distance and the lever assembly 20 does not rotate.

The first reset assembly 30 and the second reset assembly 40 may generate a resultant force for resetting the lever assembly 20, so that the magnetic element 60 is reset to the initial position of the magnetic element 60. When neither the first reset assembly 30 nor the second reset assembly 40 generates an acting force on the lever assembly 20, the lever assembly 20 and the magnetic element 60 are respectively located at their initial positions.

The housing 10 includes a first housing portion 11 and a second housing portion 12 engaged with the first housing portion. The first housing portion 11 and the second housing portion 12 are engaged with each other, to form a cavity 13, between the first housing portion 11 and the second housing portion 12, used for partially accommodating the rocker apparatus 100. The first housing portion 11 and the second housing portion 12 each include a bottom wall and a side wall extending from an outer edge of the bottom wall. The bottom walls and side walls of the first housing portion 11 and the second housing portion 12 enclose the cavity 13. In this embodiment, the first housing portion 11 is detachably connected to the second housing portion 12. In an embodiment of the present invention, the first housing portion 11 and the second housing portion 12 may be detachably connected by using a screw bolt. It may be understood that, in some other embodiments, the first housing portion 11 and the second housing portion 12 may alternatively be connected by using a snap fit, or the first housing portion 11 and the second housing portion 12 each are provided with a corresponding screw thread, to complete a threaded connection. In another possible embodiment, the first housing portion 11 and the second housing portion 12 may alternatively be integrated. It should be noted that, in another possible embodiment, the housing 10 may alternatively be integrated with the enclosure 402 of the remote controller 400. That is, the housing 10 is a part of the enclosure 402 of the remote controller 400, or a part of the enclosure 402 of the remote controller 400 may be used as the housing of the remote control apparatus 100.

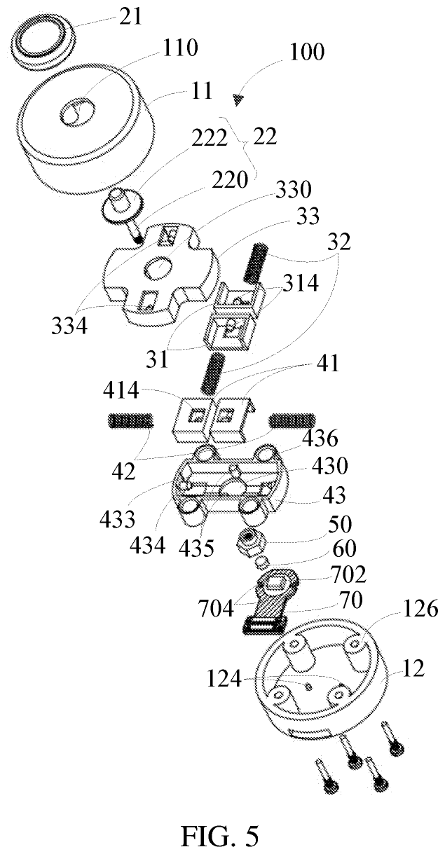

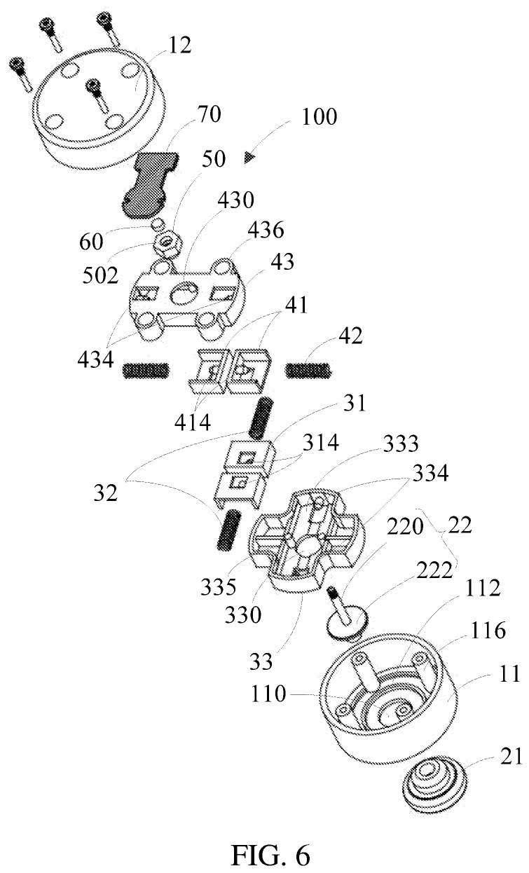

Further referring to FIG. 5 and FIG. 6, the first housing portion 11 includes an annular limiting portion 112 and a first mounting post 116. The annular limiting portion 112 is disposed at the bottom wall of the first housing portion 11. A plurality of first mounting posts 116 extends from the bottom wall of the first housing portion 11. The bottom wall of the first housing portion 11 is provided with a circular first through hole 110. A center line of the annular limiting portion 112 coincides with a center line of the first through hole 110. The first through hole 110 reserves movement space for movement of the lever assembly 20 in parallel with the housing 10.

The second housing portion 12 includes a positioning post 124 and a second mounting post 126. Two positioning posts 124 are disposed at the bottom wall of the second housing portion 12. A plurality of second mounting posts 126 extends from the bottom wall of the first housing portion 11. The number of the second mounting posts 126 is equal to the number of the first mounting posts 116. A position of each second mounting post 126 corresponds to a position of a corresponding first mounting post 116.

The lever assembly 20 includes an operating handle 21 and a lever 22. The lever 22 includes a rod body 220 and a circular slide portion 222. The rod body 220 is a cylinder. The circular slide portion 222 is sleeved over and fixed to the rod body 220. One end of the rod body 220 is fixedly connected to the operating handle 21 and the other end of the rod body 220 is fixedly connected to the fixing member 50. In this embodiment, the operating handle 21 and the lever 22 are separate elements. It may be understood that, in some other embodiments, the operating handle 21 and the lever 22 may be an integration structure.

The first reset assembly 30 includes a first movable block 31, a first elastic element 32 and a first mount 33.

There are two first movable blocks 31. Each first movable block 31 is approximately a rectangle and includes a first fixing portion 314.

There are two first elastic elements 32. In this embodiment, the first elastic element 32 is a compression spring. It may be understood that, in some other embodiments, the first elastic element 32 may be another elastic element that can provide a return spring force.

The first mount 33 is a housing and is provided with a second through hole 330 and a first accommodation groove 333. The second through hole 330 is communicated with the first accommodation groove 333. The first accommodation groove 333 is formed along a first axis. The second through hole 330 is located in the middle of a bottom wall of the first mount 33. Two opposite sides of an inner side wall of the first accommodation groove 333 each are provided with a second fixing portion 334. The other two opposite sides of the inner side wall of the first accommodation groove 333 each are provided with a first limiting post 335.

The two first movable blocks 31 are mounted in the first accommodation groove 333 and are disposed along the first axis. The two first limiting posts 335 are disposed between the two first movable blocks 31, to separate the two first movable blocks 31 by a preset distance. One end of each first elastic element 32 is mounted at one second fixing portion 334 of the first mount 33 and the other end of each first elastic element 32 is mounted at the first fixing portion 314 of one first movable block 31, so that each first elastic element 32 is compressed between the first movable block 31 and the first mount 33. Each first movable block 31 may move in the first accommodation groove 333 along the first axis, to compress the first elastic element 32 connected to the first movable block 31, or be pushed by a return spring force of the first elastic element 32 connected to the first movable block 31, to move in the first accommodation groove 333 along the first axis, until abutting against the first limiting post 335.

In this embodiment, both the first fixing portion 314 and the second fixing portion 334 are fixing posts. It may be understood that, in some other embodiments, the first fixing portion 314 and/or the second fixing portion 334 may be a slot, a hook-shaped projection, or the like, provided that one end of the first elastic element 32 can be fixed. Alternatively, the first fixing portion 314 and the second fixing portion 334 may be omitted. One end of the first elastic element 32 may be directly fixed to the inner side wall of the first accommodation groove 333 and the other end of the first elastic element 32 may be directly fixed to the first movable block 31.

It may be understood that, in some other embodiments, the number of the first movable blocks 31 is not limited to two. There may be one or more first movable blocks 31.

The second reset assembly 40 includes a second movable block 41, a second elastic element 42 and a second mount 43.

There are two second movable blocks 41. Each second movable block 41 is approximately a rectangle and includes a third fixing portion 414.

There are two second elastic elements 42. In this embodiment, the second elastic element 42 is a compression spring. It may be understood that, in some other embodiments, the second elastic element 42 may be another elastic element that can provide a return spring force.

The second mount 43 is a housing and is provided with a third through hole 430 and a second accommodation groove 433. The third through hole 430 is communicated with the second accommodation groove 433. The second accommodation groove 433 is formed along a second axis. The third through hole 430 is located in the middle of a bottom wall of the second mount 43. Two opposite sides of an inner side wall of the second accommodation groove 433 each are provided with a fourth fixing portion 434. The other two opposite sides of the inner side wall of the second accommodation groove 433 each are provided with a second limiting post 435. A plurality of third mounting posts 436 is disposed on an outer side wall of the second mount 43.

The two second movable blocks 41 are mounted in the second accommodation groove 433 and are disposed along the second axis. The two second limiting posts 435 are disposed between the two second movable blocks 41, to separate the two second movable blocks 41 by a preset distance. One end of each second elastic element 42 is mounted at one fourth fixing portion 434 of the second mount 43 and the other end of each second elastic element 42 is mounted at the third fixing portion 414 of one second movable block 41, so that each second elastic element 42 is compressed between the second movable block 41 and the second mount 43. Each second movable block 41 may move in the second accommodation groove 433 along the second axis, to compress the second elastic element 42 connected to the second movable block 31, or be pushed by a return spring force of the second elastic element 42 connected to the second movable block 31, to move in the second accommodation groove 433 along the second axis, until abutting against the second limiting post 435. The first axis is perpendicular to the second axis. Both the first axis and the second axis are parallel to the plane.

It should be noted that in various embodiments of the present invention, the first axis and the second axis refer to two virtual straight lines in directions indicated by dashed lines shown in FIG. 1. That is, the first axis is an X axis in FIG. 1 and the second axis is a Y axis in FIG. 1. Generally, the plane formed by the first axis and the second axis is approximately parallel to a center plane of a body of the remote controller. In different embodiments, the first axis and the second axis may refer to two virtual straight lines indicating any movement direction of the lever assembly, provided that the first axis is not parallel to the second axis.

In this embodiment, both the third fixing portion 414 and the fourth fixing portion 434 are fixing posts. It may be understood that, in some other embodiments, the third fixing portion 414 and/or the fourth fixing portion 434 may be a slot, a hook-shaped projection, or the like, provided that one end of the second elastic element 42 can be fixed. Alternatively, the third fixing portion 414 and the fourth fixing portion 434 may be omitted. One end of the second elastic element 42 may be directly fixed to the inner side wall of the second mount 43 and the other end of the second elastic element 42 may be directly fixed to the second movable block 41.

It may be understood that, in some other embodiments, the number of the second movable blocks 41 is not limited to two. There may be one or more second movable blocks 41.

The fixing member 50 is provided with an accommodation hole 502 and the magnetic element 60 is accommodated in and fixed to the accommodation hole 502. In this embodiment, the fixing member 50 is a fixing nut.

The circuit board 70 includes a magnetic sensor 702. The magnetic sensor 702 faces the magnetic element 60 and the magnetic sensor 702 is configured to sense a magnetic field change of the magnetic element 60. When the magnetic element 60 is located at the initial position of the magnetic element 60, the magnetic sensor 702 is aligned with the magnetic element 60 along a central axis of the lever assembly 20. Two opposite sides of the circuit board 70 each are provided with a positioning hole 704. In this embodiment, the magnetic sensor 702 is a Hall element. It may be understood that, in some other embodiments, the magnetic sensor 702 may be another element that can sense the magnetic field change, such as a magnetic encoder or a potentiometer.

When the rocker apparatus 100 is assembled, the lever 22 runs through the first through hole 110 and the operating handle 21 is fixedly mounted at one end of the lever 22. The lever 22 sequentially runs through the second through hole 330 and the third through hole 430 and the other end of the lever 22 is fixedly mounted at the fixing member 50. The two first movable blocks 31 are respectively disposed at two opposite sides of the lever 22 and the two second movable blocks 41 are respectively disposed at the other two opposite sides of the lever 22.

The circuit board 70 is fixedly mounted at the bottom wall of the second housing portion 12 and the two positioning posts 124 are correspondingly accommodated in the positioning holes 704.

The first reset assembly 30 and the second reset assembly 40 are accommodated in the first housing portion 11. The second housing portion 12 covers the first housing portion 11, so that the magnetic element 702 faces the magnetic element 60. The second mounting post 126 abuts against the second mount 43 and the first mount 33 and the second mount 43 are clamped between the second mounting post 126 and the first housing portion 11. The first mounting post 116 is aligned with the second mounting post 126 and the third mounting post 436.

A plurality of screws is inserted and fixed in the first mounting post 116 after sequentially running through the second mounting post 126 and the third mounting post 436, so as to fix the second housing portion 12, the second mount 43, the first mount 33 and the first housing portion 11 together. The circular slide block 222 is accommodated in a gap between the first mount 33 and the first housing portion 11.

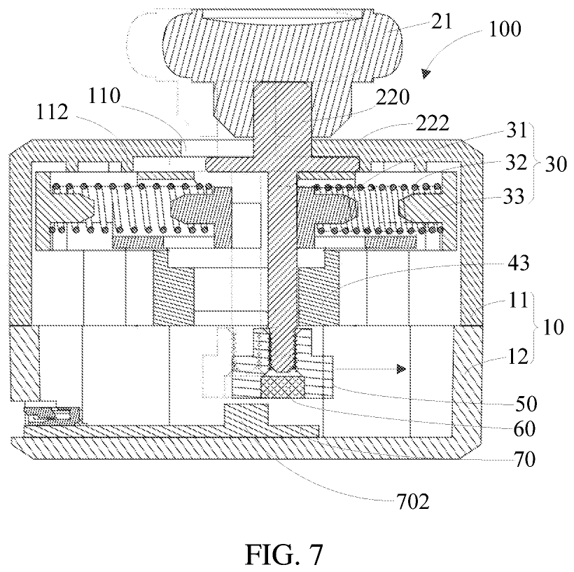

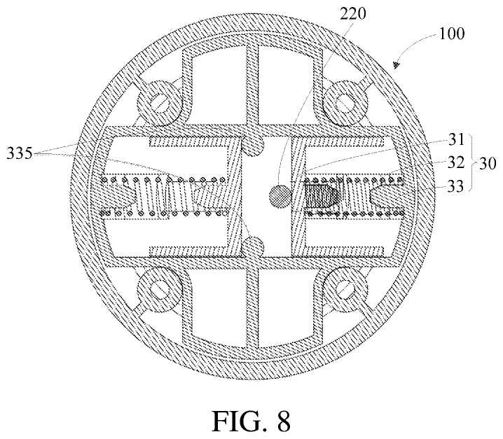

During use, referring to FIG. 7 and FIG. 8, the lever assembly 20 may be pushed to move in parallel with the housing 10 along the first axis. One of the first movable blocks 31 is pushed by the rod body 220, so that the first elastic element 32 connected to the pushed first movable block 31 is compressed. The magnetic element 60 is driven to move in parallel in the plane from the initial position of the magnetic element 60 along the first axis. The magnetic sensor 702 senses the magnetic field change of the magnetic element 60, to obtain a movement position of the magnetic element 60 along the first axis.

The remote controller 400 includes a processing unit, the processing unit being configured to generate a remote control instruction based on the movement position of the magnetic element 60 that is sensed by the magnetic sensor 702. The processing unit may be a general-purpose processor, a digital signal processor (DSP), an application-specific integrated circuit (ASIC), a field programmable gate array (FPGA), a single-chip microcomputer, an ARM (Acorn RISC Machine) or another programmable logic device, a discrete gate or a transistor logic, a discrete hardware component or any combination thereof. The processing unit generates the remote control instruction based on the movement position of the magnetic element 60 that is sensed by the magnetic sensor 702. The remote controller 400 sends the remote control instruction to a remotely controlled motorized apparatus, so that the motorized apparatus moves in a direction corresponding to the direction of the parallel movement of the lever assembly 20. The motorized apparatus may be a UAV, a navigation model, an electronic toy, or the like.

When the rod body 220 abuts against an inner wall of the first through hole 110 and the second mount 43 and the circular slide portion 222 abuts against the annular limiting portion 112, the parallel movement of the lever assembly 20 along the first axis stops. It may be understood that, in some other embodiments, according to an actual need, only the inner wall of the first through hole 110 or the second mount 43 may be selected to abut against the rod body 220, or only the circular slide portion 222 may be selected to abut against the annular limiting portion 112, to stop the parallel movement of the lever assembly 20 along the first axis.

After a thrust force on the lever assembly 20 disappears, the compressed first elastic element 32 restores and pushes the first movable block 31 to move along the first axis, so that the lever assembly 20 drives the magnetic element 60 to reset to the initial position of the magnetic element 60.

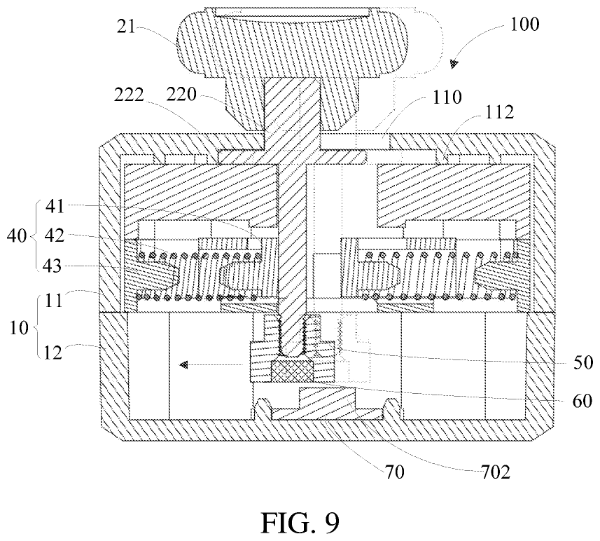

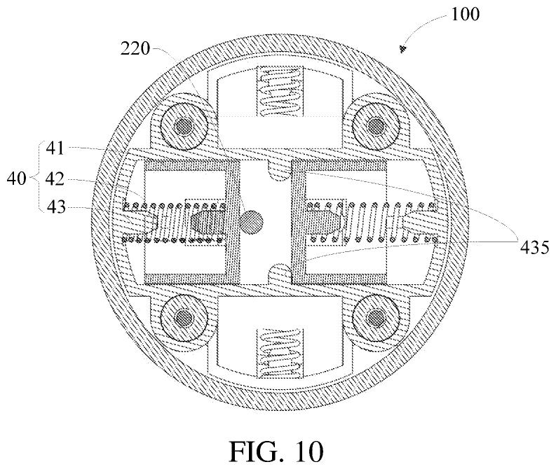

Similarly, referring to FIG. 9 and FIG. 10, the lever assembly 20 may be pushed to move in parallel with the housing 10 along the second axis. One of the second movable blocks 41 is pushed by the rod body 220, so that the second elastic element 42 connected to the pushed second movable block 41 is compressed. The magnetic element 60 is driven to move in parallel in the plane from the initial position of the magnetic element 60 along the second axis. The magnetic sensor 702 senses the magnetic field change of the magnetic element 60, to obtain a movement position of the magnetic element 60 along the second axis. The processing unit generates the remote control instruction based on the movement position of the magnetic element 60 that is obtained by the magnetic sensor 702. The remote controller 400 sends the remote control instruction to the remotely controlled motorized apparatus, so that the motorized apparatus moves in a direction corresponding to the direction of the parallel movement of the lever assembly 20.

When the rod body 220 abuts against an inner wall of the first through hole 110 and the first mount 33 and the circular slide portion 222 abuts against the annular limiting portion 112, the parallel movement of the lever assembly 20 along the second axis stops. It may be understood that, in some other embodiments, according to an actual need, only the inner wall of the first through hole 110 or the first mount 33 may be selected to abut against the rod body 220, or only the circular slide portion 222 may be selected to abut against the annular limiting portion 112, to stop the parallel movement of the lever assembly 20 along the second axis.

After a thrust force on the lever assembly 20 disappears, the compressed second elastic element 42 restores and pushes the second movable block 41 to move along the second axis, so that the lever assembly 20 drives the magnetic element 60 to reset to the initial position of the magnetic element 60.

It may be understood that, when the lever assembly 20 moves in parallel with the housing 10 in any direction, the first reset assembly 30 and the second reset assembly 40 may generate a resultant force for resetting the lever assembly 20, so that the lever assembly 20 and the magnetic element 60 thereon are reset to their initial positions. In other words, after an external force on the lever assembly 20 disappears, the first reset assembly 30 and the second reset assembly 40 coordinate and cooperate to reset the lever assembly 20 to the initial position of the lever assembly 20.

It should be understood that, the “coordination” may be understood as including the following two cases:

Case 1: The first reset assembly 30 and the second reset assembly 40 separately generate a force for resetting the lever assembly 20. The lever assembly 20 is reset to the initial position of the lever assembly 20 by using a resultant force of the two forces generated by the first reset assembly 30 and the second reset assembly 40. For example, when the lever assembly 20 moves in parallel with the housing 10 in any other direction different from the first or the second axis, because the lever assembly 20 is displaced in both directions of the first axis and the second axis, the lever assembly 20 is reset by using the resultant force of the forces generated by the first reset assembly 30 and the second reset assembly 40, so that the lever assembly 20 and the magnetic element 60 thereon are reset to their initial positions.

Case 2: Only one of the first reset assembly 30 and the second reset assembly 40 is configured to generate a force for resetting the lever assembly 20, the lever assembly 20 being reset to the initial position of the lever assembly 20 by using the force. For example, when the lever assembly 20 moves in parallel with the housing 10 only in a direction of the first axis, because the lever assembly 20 is displaced in the direction of the first axis but is not displaced in a direction of the second axis, only the first reset assembly 30 generates a force for resetting the lever assembly 20, the lever assembly 20 and the magnetic element 60 being reset to their initial positions by using the force. In this case, the second reset assembly 40 does not generate a force for resetting the lever assembly 20 Likewise, when the lever assembly 20 moves in parallel with the housing 10 only in a direction of the second axis, because the lever assembly 20 is displaced in the direction of the second axis but is not displaced in a direction of the first axis, only the second reset assembly 40 generates a force for resetting the lever assembly 20, the lever assembly 20 and the magnetic element 60 being reset to their initial positions by using the force. In this case, the first reset assembly 30 does not generate a force for resetting the lever assembly 20.

When the magnetic element 60 is driven by the lever assembly 20 to move, in parallel with the magnetic sensor 702, from the initial position of the magnetic element 60 in the plane in any direction, the magnetic sensor 702 senses the magnetic field change of the magnetic element 60 and obtains the movement position of the magnetic element 60 in the plane in any direction. The processing unit generates the remote control instruction based on the movement position of the magnetic element 60 that is sensed by the magnetic sensor 702. The remote controller 400 sends the remote control instruction to the remotely controlled motorized apparatus, so that the motorized apparatus moves in the direction corresponding to the direction of the parallel movement of the magnetic element 60.

In the rocker apparatus 100 in this embodiment of the present invention, when the magnetic element 60 is driven by the lever assembly 20 to move, in parallel with the magnetic sensor 702, from the initial position of the magnetic element 60 in the plane in any direction, the first reset assembly 30 and the second reset assembly 40 may generate a resultant force to reset the lever assembly 20, so that the magnetic element 60 is reset to the initial position of the magnetic element 60, thereby simplifying operations. In addition, the direction of the parallel movement of the lever assembly 20 may correspond to a movement direction of the remotely controlled motorized apparatus, operations for the rocker apparatus 100 are intuitive and simple, facilitating memorization of the user.

In some embodiments, the motorized apparatus is a UAV and the remote controller 400 is configured to operate and control the UAV. When the lever assembly 20 moves in parallel with the housing 10 along the first axis, for example, the lever assembly 20 moves forward or backward in parallel with the user, the remote controller 400 remotely controls the UAV to move forward or backward with respect to the user at a horizontal plane in which the UAV is located. When the lever assembly 20 moves in parallel in any direction, for example, the lever assembly 20 moves in parallel with respect to the user to the front right, the remote controller 400 remotely controls the UAV to move to the front right with respect to the user at a horizontal plane in which the UAV is located. The movement direction of the lever assembly 20 corresponds to the movement direction of the UAV, so that operations for the remote controller 400 are intuitive and simple. In addition, the first reset assembly 30 and the second reset assembly 40 may generate the resultant force to reset the lever assembly 20, so that the magnetic element 60 is reset to the initial position of the magnetic element 60, thereby simplifying operations of the remote control apparatus 400.

Finally, it should be noted that, the foregoing embodiments are used only for describing the technical solutions of the present invention, but not for limiting the technical solutions. According to the idea of the present invention, technical features in the foregoing embodiments or different embodiments may be combined, steps may be performed in any sequence and there are many other variations described above in different aspects of the present invention. For brevity, they are not provided in detail. Although the present invention is described in detail with reference to the foregoing embodiments, persons of ordinary skill in the art should understand that, they still may modify the technical solutions recorded in the foregoing embodiments, or equivalently replace some technical features thereof. These modifications or replacements do not make the nature of the corresponding technical solutions depart from the scope of the technical solutions of the embodiments of the present invention.

1. A rocker apparatus, comprising:
a housing;
a lever assembly mounted in the housing, the lever assembly being capable of moving in parallel with the housing;
a magnetic element, the magnetic element being mounted in the lever assembly; and
a circuit board comprising a magnetic sensor, the magnetic sensor being configured to sense a magnetic field change of the magnetic element, and
when the lever assembly moves in parallel with the housing, the magnetic element being driven by the lever assembly to move with respect to the magnetic sensor in any direction in a plane.

2. The rocker apparatus according to claim 1, wherein the lever assembly intersects with the plane.

3. The rocker apparatus according to claim 1, wherein when the lever assembly moves in parallel with the housing, any two points on the lever assembly move in a same direction by a same distance.

4. The rocker apparatus according to claim 1, wherein when the lever assembly moves in parallel with the housing, the lever assembly does not rotate.

5. The rocker apparatus according to claim 1, wherein the magnetic element is fixedly mounted on the lever assembly, when the lever assembly moves in parallel with the housing, the magnetic element moving in parallel with the magnetic sensor.

6. The rocker apparatus according to claim 1, further comprising a reset mechanism,
when the lever assembly deviates from an initial position of the lever assembly, the reset mechanism generating a force for resetting the lever assembly.

7. The rocker apparatus according to claim 6, wherein the reset mechanism comprises a first reset assembly and a second reset assembly,
when the lever assembly deviates from the initial position of the lever assembly, the first reset assembly and the second reset assembly generating a resultant force for resetting the lever assembly.

8. The rocker apparatus according to claim 7, wherein the first reset assembly is capable of generating a force for pushing the lever assembly along a first axis and the second reset assembly is capable of generating a force for pushing the lever assembly along a second axis; and
when the lever assembly deviates from the initial position of the lever assembly, at least one of the first reset assembly and the second reset assembly generates a force for pushing the lever assembly along a corresponding axis, so that the lever assembly returns to the initial position of the lever assembly after being released,
the first axis being not parallel to the second axis.

9. The rocker apparatus according to claim 8, wherein the first axis is perpendicular to the second axis.

10. The rocker apparatus according to claim 7, wherein the first reset assembly comprises a first movable block, a first elastic element and a first mount, the first movable block being mounted on the first mount.

11. The rocker apparatus according to claim 10, wherein there are two first movable blocks, there are two first elastic elements and a first accommodation groove is formed on the first mount;
the first accommodation groove is formed along the first axis, the two first movable blocks being accommodated in the first accommodation groove and disposed at two opposite sides of the lever assembly along the first axis; and
one end of each first elastic element is connected to an inner side wall of the first accommodation groove and the other end of each first elastic element is connected to one corresponding first movable block.

12. The rocker apparatus according to claim 11, wherein each first movable block comprises a first fixing portion;
a second fixing portion is disposed at each of two opposite sides of the inner side wall of the first accommodation groove; and
one end of each first elastic element is mounted at one second fixing portion of the first accommodation groove and the other end of each first elastic element is mounted at the first fixing portion of one corresponding first movable block.

13. The rocker apparatus according to claim 12, wherein the first fixing portion and the second fixing portion are any of the following: a fixing post, a slot and a hook-shaped projection.

14. The rocker apparatus according to claim 11, wherein a first limiting post is further disposed on the first accommodation groove, the first limiting post being disposed between the two first movable blocks to separate the two first movable blocks by a preset distance.

15. The rocker apparatus according to claim 7, wherein the second reset assembly comprises a second movable block, a second elastic element and a second mount, the second movable block being mounted on the second mount.

16. The rocker apparatus according to claim 15, wherein there are two second movable blocks, there are two second elastic elements and a second accommodation groove is formed on the second mount;
the second accommodation groove is formed along the second axis, the two second movable blocks being accommodated in the second accommodation groove and disposed at two opposite sides of the lever assembly along the second axis; and
one end of each second elastic element is connected to an inner side wall of the second accommodation groove and the other end of each second elastic element is connected to one corresponding second movable block.

17. The rocker apparatus according to claim 16, wherein each second movable block comprises a third fixing portion;
a fourth fixing portion is disposed at each of two opposite sides of the inner side wall of the second accommodation groove; and
one end of each second elastic element is mounted at one fourth fixing portion of the second accommodation groove and the other end of each second elastic element is mounted at the third fixing portion of one corresponding second movable block.

18. The rocker apparatus according to claim 17, wherein the third fixing portion and the fourth fixing portion are any of the following: a fixing post, a slot and a hook-shaped projection.

19. The rocker apparatus according to any of claim 16, wherein a second limiting post is further disposed on the second accommodation groove, the second limiting post being disposed between the two second movable blocks to separate the two second movable blocks by a preset distance.

20. The rocker apparatus according to any of claim 1, wherein the housing is provided with a first through hole, the first through hole reserving movement space for movement of the lever assembly in parallel with the housing.

21.-26. (canceled)
